(19) United States
(12) Patent Application Publication
(10) Pub. No.: US 2019/0203089 A1
(43) Pub. Date: Jul. 4, 2019

(54) POLYSULFIDE OR POLYTHIOETHER SEALANT COMPOSITION INCLUDING GLYCOL ORGANIC ACID ESTERS

(71) Applicant: 3M INNOVATIVE PROPERTIES COMPANY, St Paul, MN (US)

(72) Inventors: Gregory P. Karp, Mahtomedi, MN (US); Audrey B. Nguyen, Westminster, CA (US); Jonathan D. Zook, Stillwater, MN (US); Alla Yankovsky, Huntington Beach, CA (US); Heather N. Kinney, Stillwater, MN (US)

(21) Appl. No.: 16/320,953

(22) PCT Filed: Sep. 12, 2017
(86) PCT No.: PCT/US2017/051077

§ 371 Date: Jan. 25, 2019

Related U.S. Application Data
(60) Provisional application No. 62/397,428, filed on Sep. 21, 2016.

(51) Int. Cl. C09K 3/10; C08L 81/02; C08L 81/04

(52) U.S. Cl. CPC C09K 3/1012; C08L 81/02; C08L 81/04; C09K 2003/1046; C09K 2200/0447; C09K 2200/0488; C09K 2200/0239; C09K 2200/0247; C09K 2200/0441

(57) ABSTRACT

Various embodiments disclosed relate to polysulfide or polythioether sealant composition including glycol organic acid esters. The sealant composition can include a first component including a liquid that is a polysulfide, a polythioether, a copolymer thereof, or a combination thereof. The sealant composition can also include a second component that includes one or more glycol di((C₁-C₂₀)hydrocarbyl)carboxylate esters, wherein at each occurrence the (C₁-C₂₀)hydrocarbyl is independently substituted or unsubstituted. The second component can also include an oxidizing agent.

### BACKGROUND

Sealants are used in many industrial sectors for sealing gaps and for providing environmental isolation. Examples of industries using sealants to prevent intrusion or escape of fluids, air or dirt from joints, holes or gaps are building and construction, oil, gas and mineral mining and in transportation applications such as aircraft, automotive vehicles and marine craft. The physical and performance properties of the sealant are determined by the choice of polymer and cure chemistries and through the use of additives in the formulation. Depending on the application, sealants may be either single- or multi-component products, the choice of which depends on the user's preference or upon the specific application requirements. Regardless of whether the product is a single- or multi-component system, sealant cure rate is dependent upon temperature with cure rates increasing with elevated temperature or decreasing with reduced temperature.

Aviation fuel resistant sealants are widely used by the aircraft industry for many purposes. Principal among these uses are the sealing of integral fuel tanks and cavities, the sealing of the passenger cabin to maintain pressurization at high altitude, and for the aerodynamic smoothing of the aircraft's outer surfaces. Today's aircraft design criteria specify that sealants must be light in weight but still maintain the strength and toughness of the older high-density sealants. Additionally, the demands for increased production rates for new aircraft and faster repairs of existing aircraft have created a need for materials that cure or crosslink more rapidly than existing sealant products.

Existing sealant products now in use by the aircraft industry are typically two-component materials. These products have a first component including a fuel and temperature resistant polymer, such as a polysulfide or polythioether polymer having pendant thiol groups, as well as fillers, pigments, plasticizers, adhesion promoters and other additives. The second component includes a curing or crosslinking agent, fillers, pigments, plasticizers and other additives. Useful curing or crosslinking agents are those compounds capable of reacting with or oxidizing the pendant thiol group such that a solid, and at least partially elastomeric compound, results from the mixing of the first and second components.

Once the user mixes the first and second components, the reaction begins and the sealant starts to form into an elastomeric solid. After mixing, the time that the sealant remains usable is called the application life. Ultimately the mixed sealant begins to solidify and the time the sealant requires to reach a specific Shore A hardness is defined as the cure time. Application life and cure time are kinetic properties and in current sealants these properties are closely related in that short application life products cure quickly. Conversely, long application life products cure slowly. In practice, customers chose products with differing application lives and cure times depending on the specific application.

### SUMMARY OF THE INVENTION

In various embodiments, the present invention provides a sealant composition. The sealant composition includes a first component that includes a liquid. The liquid is a polysulfide, a polythioether, a copolymer thereof, or a combination thereof. The sealant composition also includes a second component. The second component includes one or more glycol di((C₁-C₂₀)hydrocarbyl)carboxylate esters, wherein at each occurrence the (C₁-C₂₀)hydrocarbyl is independently substituted or unsubstituted. The second component also includes an oxidizing agent.

In various embodiments, the present invention provides a reaction mixture including a mixture that includes that first component and the second component of the sealant composition.

In various embodiments, the present invention provides a kit including the first component and the second component of the sealant composition. In the kit, the first component and the second component are separate.

In various embodiments, the present invention provides a cured product of the sealant composition.

In various embodiments, the present invention provides a method of making the cured product of the sealant composition. The method includes mixing the first component and the second component to form a reaction mixture. The method includes curing the reaction mixture to form the cured product of the sealant composition.

In various embodiments, the present invention provides a method of sealing a surface. The method includes mixing the first component and the second component of the sealant composition to form a reaction mixture. The method includes applying the reaction mixture to the surface to be sealed. The method also includes curing the reaction mixture to form a cured product of the sealant composition.

In various embodiments, the present invention provides a sealant composition. The sealant composition includes a first component. The first component is about 80 wt % to about 95 wt % of the sealant composition. The sealant composition also includes a second component. The second component is about 5 wt % to about 20 wt % of the sealant composition. The second component includes wherein the second component includes one or more glycol di((C₁-C₂₀)hydrocarbyl)carboxylate esters. The one or more glycol di((C₁-C₂₀)hydrocarbyl)carboxylate esters are about 20 wt % to about 80 wt % of the second component. The one or more glycol di((C₁-C₂₀)hydrocarbyl)carboxylate esters are diethylene glycol dibenzoate and dipropylene glycol dibenzoate in a weight ratio of about 1:1 to about 6:1. The second component also includes an oxidizing agent. The oxidizing agent is about 20 wt % to about 80 wt % of the second component. The oxidizing agent is manganese dioxide. The second component also includes an organic amine catalyst. The organic amine catalyst is about 0.001 wt % to about 10 wt % of the second component. The organic amine catalyst is diphenylguanidine. The second component also includes a fatty acid. The fatty acid is about 0.001 wt % to about 10 wt % of the second component. The fatty acid is stearic acid. The second component also includes a thiuram sulfide accelerator. The thiuram sulfide accelerator is about 0.01 wt % to about 15 wt % of the second component. The thiuram sulfide accelerator is dipentamethylene thiuram hexasulfide. The second component also includes a silica filler. The silica filler is about 0.001 wt % to about 10 wt % of the second component. The silica filler is fumed silica. The second component also includes a drying agent. The drying agent is about 0.01 wt % to about 20 wt % of the second component. The drying agent is molecular sieves. The sealant composition is up to about 1.5 wt % water that is not complexed or incorporated with the drying agent. The sealant composition is substantially free of alkyl phenol ethoxylate surfactants, poly(ethylene-vinyl acetate), phthalates, chlorinated paraffins, butyl diglycols, and hydrogenated terphenyls.

In various embodiments, the present invention has certain advantages over other sealant compositions, at least some of which are unexpected. For example, in various embodiments, the sealant composition of the present invention has a long application time combined with a short set time, which is the opposite behavior normally observed and is therefore unexpected. In various embodiments, the sealant composition of the present invention has fewer phases and experiences less or no phase separation during mixing, such as due to a lack of a water phase, due to an glycol organic acid ester plasticizer that is miscible with the first component, or a combination thereof. In various embodiments, fewer phases and less or no phase separation results in faster mixing of the first and second component, faster reaction of the first and second component, or a combination thereof. In various embodiments including more than one glycol organic acid ester, the sealant composition of the present invention can have a lower freezing point or T_{g} than other sealant compositions, facilitating more convenient transport and use of the sealant composition under a greater variety of conditions as compared to other sealant compositions.

In various embodiments, the sealant composition of the present invention is substantially free of one or more, or all, SVHCs (substances of very high concern), and is therefore is acceptable under a greater number of environmental regulations than other sealant compositions. For example, in various embodiments, the sealant composition of the present invention is substantially free of alkyl phenol ethoxylate surfactants, poly(ethylene-vinyl acetate), phthalates, chlorinated paraffins, butyl diglycols, hydrogenated terphenyls, or a combination thereof. In various embodiments, the sealant composition of the present invention is suitable as an aerospace sealant or adhesive, for example, is free of components that react or dissolve with fuel, such as poly(ethylene-vinyl acetate).

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “organic group” as used herein refers to any carbon-containing functional group. Examples can include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “heterocyclyl” as used herein refers to aromatic and non-aromatic ring compounds containing three or more ring members, of which one or more is a heteroatom such as, but not limited to, N, O, and S.

The terms “halo,” “halogen,” or “halide” group, as used herein, by themselves or as part of another substituent, mean, unless otherwise stated, a fluorine, chlorine, bromine, or iodine atom.

The term “hydrocarbon” or “hydrocarbyl” as used herein refers to a molecule or functional group that includes carbon and hydrogen atoms. The term can also refer to a molecule or functional group that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Ca-Cb)hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group.

The term “number-average molecular weight” (Mn) as used herein refers to the ordinary arithmetic mean of the molecular weight of individual molecules in a sample. It is defined as the total weight of all molecules in a sample divided by the total number of molecules in the sample. Experimentally, Mₙ is determined by analyzing a sample divided into molecular weight fractions of species i having nᵢ molecules of molecular weight Mᵢ through the formula Mₙ=ΣMini/Σnᵢ. The Mₙ can be measured by a variety of well-known methods including gel permeation chromatography, spectroscopic end group analysis, and osmometry. If unspecified, molecular weights of polymers given herein are number-average molecular weights.

The term “cure” as used herein refers to exposing to radiation in any form, heating, or allowing to undergo a physical or chemical reaction that results in hardening or an increase in viscosity. A thermoset material can be cured by heating or otherwise exposing to irradiation such that the material hardens.

The term “solvent” as used herein refers to a liquid that can dissolve a solid, liquid, or gas. Non-limiting examples of solvents are silicones, organic compounds, water, alcohols, ionic liquids, and supercritical fluids.

The term “room temperature” as used herein refers to a temperature of about 15° C. to 28° C.

As used herein, the term “polymer” refers to a molecule having at least one repeating unit and can include copolymers.

### Sealant Composition.

In various embodiments, the present invention provides a sealant composition. The sealant composition can include a first component and a second component. The first component and the second component can be separate (e.g., unmixed) or mixed (e.g., mixed to any suitable degree, such as substantially homogeneously mixed). The first component can include a liquid that is a polysulfide, a polythioether, a copolymer thereof, or a combination thereof. The second component can include one or more glycol di((C₁-C₂₀)hydrocarbyl)carboxylate esters, wherein at each occurrence the (C₁-C₂₀)hydrocarbyl is independently substituted or unsubstituted. The second component can also include an oxidizing agent. Any material in the sealant composition described herein as being part of the first component can alternatively be employed in part or in whole in the second component or in another component of the sealant composition, and likewise any material described herein as being part of the second component can alternatively be employed in part or in whole in the first component or in another component of the sealant composition.

The weight ratio of the first component to the second component can be any suitable ratio, such as about 2:1 to about 14:1, or about 9:1 to about 11:1, or about 2:1 or less, or less than, equal to, or greater than about 3:1, 4:1, 5:1, 6:1, 7:1, 8:1, 9:1, 9.5:1, 10:1, 10.5:1, 11:1, 12:1, 13:1, or about 14:1 or more. The first component can be any suitable proportion of the sealant composition. The first component can be about 80 wt % to about 95 wt % of the sealant composition, about 90 wt % to about 93 wt %, about 80 wt % or less, or less than, equal to, or greater than about 81 wt %, 82, 83, 84, 85, 86, 87, 88, 89, 90, 90.5, 91, 91.5, 92, 92.5, 93, 94 wt %, or about 95 wt % or more. The second component can be any suitable proportion of the sealant composition, such as about 5 wt % to about 20 wt % of the sealant composition, or about 7 wt % to about 10 wt % of the sealant composition, or about 5 wt % or less, or less than, equal to, or greater than about 6 wt %, 7, 8, 9, 10, 11, 12, 14, 16, 18, or about 20 wt % or more.

Examples of polysulfides, polythioethers, and copolymers thereof include polymers including repeating units that include a sulfide (e.g., —S—S—) or a thioether (e.g., -thio(C₁-C₅)alkylene)-) moiety therein, and including pendant or terminal mercaptan (i.e., —SH) groups. Examples of polysulfides can include polymers formed by condensing bis(2-chloroethoxy)methane with sodium disulfide or sodium polysulfide. Examples of polythioethers include polymers formed via condensation reaction of, for example, 2-hydroxyalkyl sulfide monomers such as those described in U.S. Pat. No. 4,366,307 and those formed via addition reactions of dithiols and divinylethers such as those described in U.S. Pat. No. 6,486,297. The polysulfide, polythioether, or copolymer thereof can have any suitable molecular weight, such as a number-average molecular weight of about 500 g/mol to about 5,000 g/mol, or about 500 g/mol to about 1,500 g/mol, or about 500 g/mol or less, or less than, equal to, or greater than about 600 g/mol, 700, 800, 900, 1,000, 1,100, 1,200, 1,300, 1,400, 1,500, 1,600, 1,800, 2,000, 2,250, 2,500, 2,750, 3,000, 3,500, 4,000, 4,500, or about 5,000 g/mol or more. The polysulfide, polythioether, or copolymer thereof can have any suitable mercaptan content based on the overall weight of the liquid polysulfide, such as about 0.1 wt % to about 20 wt %, about 1 wt % to about 10 wt %, about 1 wt % to about 6 wt %, or about 1 wt % to about 3 wt %, or about 0.1 wt % or less, or less than, equal to, or greater than about 0.5 wt %, 1, 3, 4, 5, 6, 7, 8, 9, 10, 12, 14, 16, 18, or about 20 wt % or more. The polysulfide, polythioether, copolymer thereof, or combination thereof can form any suitable proportion of the first component, such as about 40 wt % to about 100 wt % of the first component, about 50 wt % to about 80 wt %, or about 40 wt % or less, or less than, equal to, or greater than about 45 wt %, 50, 55, 60, 65, 70, 75, 80, 85, 86, 88, 90, 91, 92, 93, 94, 95, 96, 97, 98, 99, 99.9 wt %, or about 99.99 wt % or more. The polysulfide, polythioether, copolymer thereof, or combination thereof can form any suitable proportion of the sealant composition, such as about 30 wt % to about 95 wt % of the sealant composition, or about 40 wt % to about 70 wt %, or about 40 wt % or less, or less than, equal to, or greater than about 45 wt %, 50, 55, 60, 65, 70, 72, 74, 76, 78, 80, 81, 82, 83, 84, 85, 86, 87, 88, 89, 90, 91, 92, 93, 94, or about 95 wt % or more.

The sealant composition can be substantially free of all water, substantially free of added water, or substantially free of water that is not complexed or incorporated with a drying agent (e.g., that is not absorbed into a drying agent). For example, the sealant composition can be up to about 1.5 wt % of all water or of water that is not complexed or incorporated with a drying agent, or about 0.5 wt % of all water or of water that is not complexed or incorporated with a drying agent.

The sealant composition can be substantially free of poly(ethylene-vinyl acetate). The sealant composition can be substantially free of one or more substances of very high concern (e.g., SVHCs), such as substantially free of alkyl phenol ethoxylate surfactants, phthalates, chlorinated paraffins, butyl diglycols, hydrogenated terphenyls, or a combination thereof. The term “substantially free of” can mean having a trivial amount of, such that the amount of material present does not affect the material properties of the sealant composition, such that the composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less. Substances of very high concern can be substances that have serious and sometimes irreversible effects on human health or the environment, such as substances defined as SVHCs by the European Chemicals Agency (ECHA).

### Glycol Organic Acid Ester.

The second component can include one or more glycol di((C₁-C₂₀)hydrocarbyl)carboxylate esters, wherein at each occurrence the (C₁-C₂₀)hydrocarbyl is independently substituted or unsubstituted. The one or more glycol di((C₁-C₂₀)hydrocarbyl)carboxylate esters can form any suitable proportion of the second component, such as about 20 wt % to about 80 wt % of the second component, or about 30 wt % to about 60 wt %, or about 20 wt % or less, or less than, equal to, or greater than about 25 wt %, 30, 32, 34, 36, 38, 40, 42, 44, 46, 48, 50, 52, 54, 56, 58, 60, 65, 70, 75 wt %, or about 80 wt % or more of the second component. The one or more glycol di((C₁-C₂₀)hydrocarbyl)carboxylate esters can form any suitable proportion of the sealant composition, such as about 1 wt % to about 20 wt % of the sealant composition, or about 2 wt % to about 10 wt %, or about 1 wt % or less, or less than, equal to, or greater than about 2 wt %, 3, 4, 5, 6, 7, 8, 9, 10, 12, 14, 16, 18 wt %, or about 20 wt % or more of the sealant composition.

The glycol di((C₁-C₂₀)hydrocarbylcarboxylate ester can be a glycol diphenylcarboxylate ester. At each occurrence the phenyl group is independently substituted or unsubstituted. The glycol di((C₁-C₂₀)hydrocarbylcarboxylate ester can be a glycol dibenzoate ester. The glycol of the glycol di((C₁-C₂₀)hydrocarbylcarboxylate ester can have the structure HO—(R—O)ₙ—H, wherein R is (C₂-C₃)hydrocarbylene and n is 1 to 100. The glycol of the glycol di((C₁-C₂₀)hydrocarbylcarboxylate ester can be ethylene glycol, diethylene glycol, triethylene glycol, tetraethylene glycol, propylene glycol, dipropylene glycol, tripropylene glycol, tetrapropylene glycol, 2,2,4-trimethyl-1,3-pentanediol, or neopentyl glycol hydroxypivalate.

The second component can include more than one of the glycol di((C₁-C₂₀)hydrocarbyl)carboxylate esters. The second component can include two of the glycol di((C₁-C₂₀)hydrocarbyl)carboxylate esters, wherein the glycol of one of the glycol di((C₁-C₂₀)hydrocarbyl)carboxylate esters has a greater molecular weight than the glycol of another one of the glycol di((C₁-C₂₀)hydrocarbyl)carboxylate esters. The glycol di((C₁-C₂₀)hydrocarbyl)carboxylate ester having the greater molecular weight can be dipropylene glycol dibenzoate and the glycol di((C₁-C₂₀)hydrocarbyl)carboxylate ester having the lesser molecular weight can be diethylene glycol dibenzoate. The weight ratio of the glycol di((C₁-C₂₀)hydrocarbyl)carboxylate ester having the lesser molecular weight to the glycol di((C₁-C₂₀)hydrocarbyl)carboxylate ester having the greater molecular weight can be any suitable ratio, such as about 1:1 to about 6:1, about 2:1 to about 5:1, or about 1:1 or less, or less than, equal to, or greater than about 2:1, 2.5:1, 3:1, 3.5:1, 4:1, 4.5:1, 5:1, or about 6:1 or more.

The second component can include diethylene glycol dibenzoate, dipropylene glycol dibenzoate, or a combination thereof. The second component can include diethylene glycol dibenzoate and dipropylene glycol dibenzoate, such as in a weight ratio of about 1:1 to about 6:1, about 2:1 to about 5:1, or about 1:1 or less, or less than, equal to, or greater than about 2:1, 2.5:1, 3:1, 3.5:1, 4:1, 4.5:1, 5:1, or about 6:1 or more.

### Oxidizing Agent.

The second component can also include an oxidizing agent. The second component can include one oxidizing agent or multiple oxidizing agents. The one or more oxidizing agents can form any suitable proportion of the second component, such as about 20 wt % to about 80 wt % of the second component, or about 30 wt % to about 60 wt %, or about 20 wt % or less, or less than, equal to, or greater than about 25 wt %, 30, 32, 34, 36, 38, 40, 42, 44, 46, 48, 50, 52, 54, 56, 58, 60, 65, 70, 75 wt %, or about 80 wt % or more. The one or more oxidizing agents can form any suitable proportion of the sealant composition, such as about 1 wt % to about 20 wt % of the sealant composition, about 2 wt % to about 10 wt %, or about 1 wt % or less, or less than, equal to, or greater than about 2 wt %, 3, 4, 5, 6, 7, 8, 9, 10, 12, 14, 16, 18 wt %, or about 20 wt % or more of the sealant composition.

The oxidizing agent can be any suitable oxidizing agent, such that the sealant composition can be used as described herein. For example, the oxidizing agent can be lead dioxide, manganese dioxide, p-quinone dioxime, zinc peroxide, or combination thereof. The oxidizing agent can be manganese dioxide.

### Drying Agent.

The second component can further include a drying agent, for example, a hygroscopic material that has a higher affinity for water than other components of the sealant composition. The second component can include one drying agent or more than one drying agent. The one or more drying agents can form any suitable proportion of the second component, such as about 0.01 wt % to about 20 wt % of the second component, about 0.1 wt % to about 10 wt %, or about 0.01 wt % or less, or less than, equal to, or greater than about 0.1 wt %, 1, 2, 3, 4, 5, 6, 7, 8, 9, 10, 12, 14, 16, 18, or about 20 wt % or more. The one or more drying agents can form any suitable proportion of the sealant composition, such as about 0.0001 wt % to about 5 wt % of the sealant composition, or about 0.001 wt % to about 1 wt % of the sealant composition, or about 0.0001 wt % or less, or less than, equal to, or greater than about 0.0005 wt %, 0.001, 0.005, 0.01, 0.05, 0.1, 0.5, 1, 1.5, 2, 2.5, 3, 4 wt %, or about 5 wt % or more.

The drying agent can be any suitable drying agent, such that the sealant composition can be used as described herein. For example, the drying agent can be calcium oxide, barium oxide, molecular sieves, or a combination thereof. The drying agent can be molecular sieves, such as a type 3A zeolite filler.

### Organic Amine Catalyst.

The second component can further include an organic amine catalyst. The second component can include one organic amine catalyst or more than one organic amine catalyst. The one or more organic amine catalysts can be any suitable proportion of the second component, such as about 0.001 wt % to about 10 wt % of the second component, or about 0.01 wt % to about 5 wt %, or about 0.001 wt % or less, or about 0.005 wt %, 0.01, 0.05, 0.1, 0.2, 0.3, 0.4, 0.5, 0.6, 0.7, 0.8, 0.9, 1, 1.5, 2, 2.5, 3, 4 wt %, or about 5 wt % or more of the second component. The one or more organic amine catalysts can be any suitable proportion of the sealant composition, such as about 0.00001 wt % to about 2 wt % of the sealant composition, about 0.0001 wt % to about 1 wt %, or about 0.00001 wt % or less, or less than, equal to, or greater than about 0.00005 wt %, 0.0001, 0.0005, 0.001, 0.005, 0.01, 0.02, 0.03, 0.04, 0.05, 0.06, 0.07, 0.08, 0.09, 0.1, 0.5 wt %, or about 1 wt % or more.

The organic amine catalyst can be any suitable organic amine catalyst such that the sealant composition can be used as described herein. The organic amine catalyst can be an organic tertiary amine. The organic amine catalyst can be guanidine or a guanidine derivative. The organic amine catalyst can include tetramethylguanidine, diphenylguanidine, di-o-tolylguanidine, 1-(o-tolyl)biguanide, or a combination thereof. The organic amine catalyst can be diphenylguanidine.

### Thiuram Sulfide Accelerator.

The second component can further include a thiuram sulfide accelerator. The second component can include one thiuram sulfide accelerator or more than one thiuram sulfide accelerator. The one or more thiuram sulfide accelerators can be any suitable proportion of the second component, such as about 0.01 wt % to about 15 wt % of the second component, about 0.1 wt % to about 10 wt %, or about 0.01 wt % or less, or less than, equal to, or greater than about 0.05 wt %, 0.1, 0.5, 1, 1.5, 2, 2.5, 3, 3.5, 4, 4.5, 5, 6, 7, 8, 9, 10, 11, 12, 13, 14 wt %, or about 15 wt % or more. The one or more thiuram sulfide accelerators can be any suitable proportion of the sealant composition, such as about 0.0001 wt % to about 3 wt % of the sealant composition, or about 0.001 wt % to about 1 wt %, or about 0.0001 wt % or less, or less than, equal to, or greater than about 0.0005, 0.001, 0.005, 0.01, 0.05, 0.1, 0.2, 0.3, 0.4, 0.5, 0.6, 0.7, 0.8, 0.9, 1, 1.5, 2, 2.5 wt %, or about 3 wt % or more of the sealant composition.

The thiuram sulfide accelerator can be any suitable thiuram sulfide accelerator such that the sealant composition can be used as described herein. The thiuram sulfide accelerator can include tetramethyl thiuram monosulfide, tetramethyl thiuram disulfide, tetraethyl thiuram disulfide, tetrabutyl thiuram disulfide, dipentamethylene thiuram hexasulfide, dicyclohexamethylene thiuram disulfide, diisopropyl thiuram disulfide, bis(morpholinothiocarbonyl) sulfide, or a combination thereof. The thiuram sulfide accelerator can be dipentamethylene thiuram hexasulfide.

### Fatty Acid.

The second component can include a fatty acid. The second component can include one fatty acid or more than one fatty acid. The one or more fatty acids can be any suitable proportion of the second component, such as about 0.001 wt % to about 10 wt % of the second component, or about 0.01 wt % to about 5 wt % of the second component, or about 0.001 wt % or less, or less than, equal to, or greater than about 0.005, 0.01, 0.05, 0.1, 0.2, 0.3, 0.4, 0.5, 0.6, 0.7, 0.8, 0.9, 1, 1.1, 1.2, 1.3, 1.4, 1.5, 1.6, 1.8, 2, 2.5, 3, 4, 5, 6, 7, 8, 9 wt %, or about 10 wt % or more. The one or more fatty acids can be any suitable proportion of the sealant composition, such as about 0.00001 wt % to about 2 wt % of the sealant composition, or about 0.0001 wt % to about 0.5 wt %, or about 0.00001 wt % or less, or less than, equal to, or greater than about 0.00005 wt %, 0.0001, 0.0005, 0.001, 0.005, 0.01, 0.02, 0.03, 0.04, 0.05, 0.06, 0.07, 0.08, 0.09, 0.1, 0.15, 0.1, 0.2, 0.3, 0.4, 0.5, 0.6, 0.7, 0.8, 0.9, 1, 1.2, 1.4, 1.6, 1.8 wt %, or about 2 wt % or more of the sealant composition.

The fatty acid can be any suitable fatty acid such that the sealant composition can be used as described herein. The fatty acid can be a (C₆-C₁₀₀)fatty acid. The fatty acid can be stearic acid.

### Filler.

The second component can include a filler. The second component can include one filler, or more than one filler. The filler can be any suitable filler, such that the sealant composition can be used as described herein. The filler can be fibrous or particulate. The filler can be glass fibers, aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, zinc oxide, or the like; calcium sulfate (as its anhydride, dehydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin; single crystal fibers or “whiskers” such as silicon carbide, alumina, boron carbide, iron, nickel, copper, or the like; fibers (including continuous and chopped fibers) such as asbestos, carbon fibers; sulfides such as molybdenum sulfide, zinc sulfide, or the like; barium compounds such as barium titanate, barium ferrite, barium sulfate, heavy spar, or the like; metals (e.g., metal mesh, metal plate) and metal oxides such as particulate or fibrous aluminum, bronze, zinc, copper and nickel, or the like; flaked fillers such as glass flakes, flaked silicon carbide, aluminum diboride, aluminum flakes, steel flakes or the like; fibrous fillers, for example short inorganic fibers such as those derived from blends including at least one of aluminum silicates, aluminum oxides, magnesium oxides, and calcium sulfate hemihydrate or the like; natural fillers and reinforcements, such as wood flour obtained by pulverizing wood, fibrous products such as kenaf, cellulose, cotton, sisal, jute, flax, starch, corn flour, lignin, ramie, rattan, agave, bamboo, hemp, ground nut shells, corn, coconut (coir), rice grain husks or the like; organic fillers such as polytetrafluoroethylene, reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as fillers such as mica, clay, feldspar, flue dust, fillite, quartz, quartzite, perlite, Tripoli, diatomaceous earth, carbon black, or the like, or combinations including at least one of the foregoing fillers. The filler can surface treated with silanes, siloxanes, or a combination of silanes and siloxanes to improved adhesion and dispersion. The filler can be a silica filler. The silica filler can be any suitable silica filler, such that the sealant composition can be used as described herein. The silica filler can be fumed silica.

The filler can be rigid hollow particles such as 3M Glass Microspheres from 3M Company or ECCOSPHERES brand hollow glass microspheres from Trelleborg AB, Trelleborg, Sweden. Such fillers can significantly reduce the density of a composition while preserving acceptable mechanical properties after curing. Advantageously, the inclusion of hollow filler particles can significantly reduce the density of the composition and hence the overall weight of the composition in practice. The density of the filler particles can be less than, equal to, or greater than 0.18 g/cm³, 0.3, 0.5, 0.6, 0.8, 1.0, 1.2, 1.4, 1.6, 1.8, or 2 or more.

As a further option, the first and/or second component may further include one or more solid (non-hollow) inorganic fillers. The type of inorganic filler is not especially restricted and could include, for example, fumed silica or calcium carbonate. Useful fillers also include chopped fibers, such as chopped carbon or graphite fibers, glass fibers, boron fibers, silicon carbide fibers, and combinations thereof.

The one or more fillers can form any suitable proportion of the second component, such as about 0.001 wt % to about 10 wt % of the second component, about 0.01 wt % to about 5 wt %, or about 0.001 wt % or less, or less than, equal to, or greater than about 0.005 wt %, 0.01 wt %, 0.05, 0.1, 0.2, 0.3, 0.4, 0.5, 0.6, 0.7, 0.8, 0.9, 1, 1.5, 2, 2.5, 3, 4, 5, 6, 7, 8, 9 wt %, or about 10 wt % or more of the second component. The one or more fillers can form any suitable proportion of the sealant composition, such as about 0.00001 wt % to about 2 wt % of the sealant composition, or about 0.0001 wt % to about 0.5 wt %, or about 0.00001 wt % or less, or about 0.00005 wt %, 0.0001, 0.0005, 0.001, 0.005, 0.01, 0.02, 0.03, 0.04, 0.05, 0.06, 0.07, 0.08, 0.09, 0.1, 0.15, 0.2, 0.4, 0.6, 0.8, 1, 1.2, 1.4, 1.6, 1.8, or about 2 wt % or more of the sealant composition.

### Other Components.

The sealant composition, the first component, the second component, or a combination thereof, can optionally include or be free of any one or more suitable optional components, such as a filler, pigment, adhesion promotor (e.g., organofunctional trialkoxysilanes), plasticizer, or a combination thereof. Examples of adhesion promoters include 3 -glycidoxypropyltrialkoxysilane, 3 -acryloxypropyltrialkoxysilane, 3-aminopropyltrialkoxysilane, vinyltrialkoxysilane, N-aminoethyl-3-aminopropylmethyldialkoxysilane, phenylaminopropyltrialkoxysilane, aminoalkyltrialkoxydisilane, and i-butylmethoxysilane. In some embodiments, the alkoxy groups are independently methoxy or ethoxy groups.

### Properties of the Sealant Composition.

The sealant composition and the cured product thereof can have any suitable properties consistent with the composition of the sealant composition described herein.

A reaction mixture including a mixture of the first component and the second component can have any suitable Tack-Free Time, which represents the length of time after mixing the first and second component that the mixture can be cleanly contacted (e.g., contacted by a substrate such as polyethylene film such that upon removal of the substrate none of the mixture is adhered to the substrate). For example, a reaction mixture including a mixture of the first component and the second component can have a Tack-Free Time at room temperature of about 0.5 h to about 15 h after mixing of the first component and the second component, or about 2 h to about 8 h, or about 0.5 h to about 3 h, or about 0.5 h or less, or less than, equal to, or greater than about 1 h, 2, 3, 4, 5, 6, 7, 8, 9, 10, 11, 12, 13, 14 h, or about 15 h or more after mixing of the first component and the second component.

A reaction mixture including a mixture of the first component and the second component can have a cure time at room temperature, which refers to the length of time it takes the reaction mixture, after mixing the first and second component, when held at 25° C. and 50% RH, to achieve a Shore A Hardness of at least 30. For example, a reaction mixture including a mixture of the first component and the second component can have a cure time at room temperature of about 0.5 h to about 15 h after mixing of the first component and the second component, or about 3 h to about 9 h, or about 0.5 h or less, or less than, equal to, or greater than about 1 h, 2, 3, 4, 5, 6, 7, 8, 9, 10, 11, 12, 13, 14 h, or about 15 h or more.

A reaction mixture including a mixture of the first component and the second component can have any suitable Application Time at room temperature, the quantity of mixed sealant, after being mixed and held for 2 hours at 25° C., that can be dispensed from a pneumatic sealing gun in 1 minute, at a line pressure of 90 psi (620.5 kPa). For example, a reaction mixture including a mixture of the first component and the second component can have an Application Time at room temperature of about 10 g/min to about 300 g/min about 2 hours after mixing of the first component and the second component, or about 15 g/min to about 150 g/min, or about 10 g/min or less, or less than, equal to, or greater than about 15 g/min, 20, 25, 30, 35, 40, 45, 50, 55, 60, 65, 70, 75, 80, 85, 90, 95, 100, 105, 110, 115, 120, 125, 130, 135, 140, 145, 150, 160, 170, 180, 190, 200, 225, 250, 275 g/min, or about 300 g/min or more about 2 hours after mixing of the first component and the second component.

After curing at room temperature, a reaction mixture including a mixture of the first component and the second component can have any suitable cured strength (e.g., the strength of the cured product of the first component and the second component after curing is substantially complete), such as about 10 A to about 75 A (i.e., wherein A designates Shore A hardness), or about 20 A to about 50 A, or about 10 A or less, or less than, equal to, or greater than about 15 A, 20, 25, 30, 35, 40, 45, 50, 55, 60, 65, 70 A, or about 75 A or more.

### Reaction Mixture.

In various embodiments, the present invention provides a reaction mixture. The reaction mixture includes the first component and the second component of any embodiment of the sealant composition described herein. The first component and the second component can be mixed, such as substantially homogeneously mixed.

### Kit.

In various embodiments, the present invention provides a kit. The kit can include the first component and the second component of any embodiment of the sealant composition described herein. In the kit, the first component and the second component can be separate (e.g., unmixed).

### Cured Product.

In various embodiments, the present invention provides a cured product of the sealant composition. The sealant composition can be any embodiment of the sealant composition described herein. The cured product can form by the curing a reaction mixture formed by mixing the first and second component of the sealant composition. The cured product can be any suitable cured product that results from curing the reaction mixture.

The curing can be carried out in any suitable way. The curing can occur at room temperature, at a temperature below room temperature (e.g., with cooling, or with cool ambient conditions), or at a temperature above room temperature (e.g., with heating, or with hot ambient conditions). The curing can include irradiating the reaction mixture, such as with visible light, infrared light, microwaves, radio waves, very low frequency waves, extremely low frequency waves, thermal radiation (heat), black-body radiation, or a combination thereof, or the curing can be free of irradiation.

### Method of Making a Cured Product.

In various embodiments, the present invention provides a method of making a cured product of the sealant composition. The method can include mixing the first component and the second component of any embodiment of the sealant composition described herein to form a reaction mixture. The method can also include curing the reaction mixture to form the cured product of the sealant composition.

### Method of Sealing a Surface.

In various embodiments, the present invention provides a method of sealing a surface. The method can include mixing the first component and the second component of any embodiment of the sealant composition described herein to form a reaction mixture. The method can include applying the reaction mixture to the surface to be sealed. The mixing can occur before the applying, during the applying, or a combination thereof. The method can include curing the reaction mixture on the surface to be sealed to form a cured product of the sealant composition (e.g., a cured product of the reaction mixture) on the surface, to form a sealed surface.

### EXAMPLE

Various embodiments of the present invention can be better understood by reference to the following Examples which are offered by way of illustration. The present invention is not limited to the Examples given herein.

Unless otherwise noted, all reagents were obtained or are available from Sigma-Aldrich Company, St. Louis, Mo., or may be synthesized by known methods. Unless otherwise reported, all ratios are by weight percent.

The following abbreviations are used to describe the examples:

| | |
|---|---|
| ° C. | degrees Centigrade |
| ° F. | degrees Fahrenheit |
| cm | centimeter |
| g/cm² | gram per square centimeter |
| lb | pound |
| Kg | kilogram |
| oz/in² | ounces per square inch |
| RH | relative humidity |
| rpm | revolutions per minute |

Abbreviations for the materials used in the examples are as follows:

| | |
|---|---|
| AC- | Part B of a two-part polysulfide-based, manganese cured, sealant, obtained under |
| 350B2 | the trade designation “AEROSPACE SEALANT AC-350 CLASS B2” from 3M |
| | Company, St. Paul, Minnesota. |
| DPG | N,N-diphenylguanidine, obtained from Western Reserve Chemical Corporation, |
| | Stow, Ohio. |
| DPPT | Dipentamethylenethiuram hexasulfide, obtained from R.T. Vanderbilt Company, |
| | Inc., Norwalk, Connecticut. |
| HB-40 | A blend of hydrogenated terphenyl/quaterphenyl plasticizers, obtained under the |
| | trade designation “HB-40” from Eastman Chemical Company, Kingsport, |
| | Tennessee. |
| K-FLEX | A blend of dipropylene glycol dibenzoate and diethylene glycol dibenzoate |
| | plasticizers, obtained under the trade designation “K-FLEX 850P” from Emerald |
| | Performance Materials, LLC, Cuyahoga Falls, Ohio. |
| MD-FA | Manganese dioxide, obtained under the trade designation “MANGANESE |
| | DIOXIDE (IV) TYPE FA” from Honeywell Specialty Materials, Morris Plains, |
| | New Jersey. |
| MD-TV | Manganese dioxide, obtained under the trade designation “MANGANESE |
| | DIOXIDE, ACTIVATED, TYPE V” Shepherd Color Company, Cincinnati, |
| | Ohio. |
| MOLSIV | A moisture adsorbant, obtained under the trade designation “MOLSIV 3A” from |
| | Honeywell Specialty Materials. |
| R-8200 | A hexamethyldisilazane modified fumed silica, obtained under the trade |
| | designation “AEROSIL R-8200” from Evonik Industries, AG, Essen, Germany. |
| SA | A C₁₆ and C₁₈ blend stearic acid vegetable powder, obtained from Amico |
| | Scientific Corporation, Garden Grove, California. |
| TMG | 1,1,3,3-tetramethylguanidine, obtained from Lonza Group Ltd., Basel, |
| | Switzerland. |

### Test Methods.

Application Time (AT) represents the quantity of mixed sealant, after being mixed and held for 2 hours at 25° C., that can be dispensed from a pneumatic sealing gun in 1 minute, at a line pressure of 90 psi (620.5 kPa).

Tack-Free Time (TFT) represents the length of time before the mixed sealant can be cleanly contacted. Mixed sealant was manually spread onto a clean aluminum coupon at a thickness of approximately 0.13 inches (0.33 cm). A 1 by 7 inch by 6 mil (2.54 by 17.78 cm by 152.4 μm) low density polyethylene film was then applied over the sealant and a 0.5 oz/in² (2.20 g/cm²) weight was then applied onto the film. The assembly was then held for 2 minutes at 25° C. and 50% RH, after which the weight was removed and the film was slowly removed at a right angle to the sealant. The procedure was repeated until the low density polyethylene film was cleanly removed from the sealant.

Cure Time (CT) refers to the length of time it takes the mixed sealant, when held at 25° C. and 50% RH, achieves a Shore A Hardness of at least 30. Values reported herein record the Shore A Hardness at the Cure Time reported.

### Example 1

Stock Catalyst. KFLEX (14.18 lbs, 6.43 Kg) was added to a stainless steel vessel at 70° F. (21.1° C.). To this was added 0.07 lbs (31.8 grams) R-8200 and the mixture stirred at 800 rpm for approximately until homogeneous. 9.93 lbs (4.50 Kg) MD-TV and 4.26 lbs (1.93 Kg) MD-FA were added, incrementally to prevent an exotherm, and mixing speed increased to 1,000 rpm. After 5 minutes, 1.69 lbs (766.6 grams) MOLSIV was also added and the mixing speed increased to 1,500 rpm for an additional 20 minutes. The resultant premix was then transferred to an oven and held at 120° F. (48.9° C.) for 16 hours, after which it was cooled to 70° F. (21.1° C.).

Intermediate 1A. The stock catalyst (13.49 lbs, 6.12 Kg) was transferred to a stainless steel mixing vessel, to which 1.27 lbs (576.1 grams) DPTT and 0.24 lbs (108.9 grams) SA were slowly added at 21° C. and the mixture manually stirred until homogeneous.

Intermediate 1B. The stock catalyst (2.92 lbs, 1.33 Kg) was transferred to another stainless steel mixing vessel, to which 0.075 lbs (34.0 grams) DPG was added at 21° C. and the mixture manually stirred until homogeneous.

The stock catalyst (165 grams), 120 grams of Intermediate 1A and 15 grams Intermediate 1B were manually blended at 21° C. until homogeneous, representing Example 1.

Example 1 (1 part) was homogeneously mixed with 10 parts by weight AC-350B2 at 21° C. in a plastic cup by means of a spatula, after which the resultant sealant was transferred to a model SEMCO cartridge fitted with a 4 inch (10.16 cm) nozzle and a 1.8 inch (4.57 cm) tip. The sealant was then dispensed by means of a pneumatic sealant gun at a line pressure of approximately 90 psi (620.5 kPa). Application Time (AT), Tack-Free Time (TFT), and Cure Time (CT) were then recorded. AT, TFT and CT evaluations were again determined on sealants prepared as described above, wherein samples of AC-350B2 base were held for 2 months and 3 months at both 21° C. and −40° C. With respect to the latter, the AC-350B2 was removed from the freezer 24 hours prior to mixing with Example 1 in order for it to equilibrate to 21° C. Meanwhile, the stock catalyst was sealed and held for 2 and 3 months at 77° F. (25° C.). Results are listed in Table 1.

TABLE 1

| | Base Storage Condition | | | | |
|---|---|---|---|---|---|
| Sealant | | 2 Months | 3 Months | 2 Months | 3 Months |
| Test | Initial | @ 25° C. | @ 25° C. | @ −40° C. | @ −40° C. |
| AT | 49 | 43 | 34 | 59 | 42 |
| (g/min) | | | | | |
| TFT | 3.5 | 4.5 | 4.5 | 4.5 | 4.5 |
| (hours) | | | | | |
| CT | 5.75 | 5.50 | 5.50 | 6.50 | 5.00 |
| (hours) | | | | | |
| Shore A | 37 | 32 | 39 | 30 | 31 |
| Hardness | | | | | |

### Example 2

Stock Catalyst. KFLEX (188.24 grams) and 0.94 grams A8200 was added to a type DAC MAX 300 cup at 21° C. and homogeneously dispersed using a model “DAC 400 FVZ” mixer at 1,000 rpm for approximately 2 minutes. The cup was removed from the mixer and 131.75 grams MD-T5 and 56.47 grams MD-FA were slowly added. After manually incorporating, the cup was returned to the DAC mixer and homogeneously dispersed for 2 minutes at 1,000 rpm. The cup was transferred to an air motor mixer fitted with a Cowles sawtooth type FB6 dispersion blade. MOLSIV (22.59 grams) was added and mixed for 2 minutes. The stock catalyst was then evenly divided into two sealed portions, one portion (SC-77) maintained at 77° F. (25° C.), the other portion (SC-120) maintained at 120° F. (48.9° C.), for 7 days.

Intermediate 2A. Stock Catalyst SC-77 (130 grams) was transferred to a mixing cup, to which 12.24 grams DPTT and 2.32 grams SA were slowly added at 21° C. and the mixture dispersed using the Cowles blade for 2 minutes until homogeneous.

Intermediate 2B. SC-77 (90 grams) was transferred to a mixing cup, to which 2.31 grams DPT was slowly added at 21° C. and the mixture dispersed using the Cowles blade for 2 minutes until homogeneous.

SC-77 (110 grams), 80 grams of Intermediate 2A and 10 grams Intermediate 2B were blended at 21° C. for 5 minutes using the Cowles blade. Example 2 was then separated into three equal portions. A sealant was prepared from one portion of Example 2 using AC-350B2 base that had been stored at −40° C., and subsequently equilibrated to 25° C. 24 hours prior to using, according to the method generally described in Example 1. The resultant sealant was then evaluated for Application Time (AT), Tack-Free Time (TFT) and Cure Time (CT). AT, TFT and CT evaluations were subsequently determined on sealants prepared from the remaining two portions of Example 2, wherein one portion of the catalyst had been sealed and stored for 60 days at 77° F. (25° C.), and the other sealed and stored for 15 days at 120° F. (48.9° C.). Results are listed in Table 2.

### Example 3

Sealants were prepared and evaluated according to the procedure generally described in Example 2, wherein Stock Catalyst SC-77 was substituted by equal quantities of Stock Catalyst SC-120. AT, TFT, CT and ST evaluations are also reported in Table 2.

TABLE 2

| | Example 2 | | | Example 3 | | |
|---|---|---|---|---|---|---|
| | Storage Conditions | | | Storage Conditions | | |
| | | 60 | 15 | | 60 | 15 |
| | Ini- | Days @ | Days @ | Ini- | Days @ | Days @ |
| Sealant Test | tial | 25° C. | 48.9° C. | tial | 25° C. | 48.9° C. |
| AT (g/min) | 87 | 90 | 49 | 72 | 70 | 42 |
| TFT (hours) | 5.0 | 6.0 | 4.0 | 5.0 | 5.0 | 4.0 |
| CT (hours) | 7.0 | 7.0 | 5.5 | 6.5 | 5.5 | 6.0 |
| Shore A | 38 | 32 | 30 | 35 | 30 | 30 |
| Hardness | | | | | | |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments

The following exemplary embodiments are provided, the numbering of which is not to be construed as designating levels of importance:

Embodiment 1 provides a sealant composition comprising:

a first component comprising a liquid that is a polysulfide, a polythioether, a copolymer thereof, or a combination thereof; and

a second component comprising

one or more glycol di((C₁-C₂₀)hydrocarbyl)carboxylate esters, wherein at each occurrence the (C₁-C₂₀)hydrocarbyl is independently substituted or unsubstituted; and

an oxidizing agent.

Embodiment 2 provides the sealant composition of Embodiment 1, wherein the first component and the second component are separate.

Embodiment 3 provides the sealant composition of any one of Embodiments 1-2, wherein the first component and the second component are mixed.

Embodiment 4 provides the sealant composition of any one of Embodiments 1-3, wherein the weight ratio of the first component to the second component is about 2:1 to about 14:1.

Embodiment 5 provides the sealant composition of any one of Embodiments 1-4, wherein the weight ratio of the first component to the second component is about 9:1 to about 11:1.

Embodiment 6 provides the sealant composition of any one of Embodiments 1-5, wherein the first component is about 80 wt % to about 95 wt % of the sealant composition.

Embodiment 7 provides the sealant composition of any one of Embodiments 1-6, wherein the first component is about 90 wt % to about 93 wt % of the sealant composition.

Embodiment 8 provides the sealant composition of any one of Embodiments 1-7, wherein the second component is about 5 wt % to about 20 wt % of the sealant composition.

Embodiment 9 provides the sealant composition of any one of Embodiments 1-8, wherein the second component is about 7 wt % to about 10 wt % of the sealant composition.

Embodiment 10 provides the sealant composition of any one of Embodiments 1-9, wherein the polysulfide, polythioether, copolymer thereof, or combination thereof is about 40 wt % to about 100 wt % of the first component.

Embodiment 11 provides the sealant composition of any one of Embodiments 1-10, wherein the polysulfide, polythioether, copolymer thereof, or combination thereof is about 50 wt % to about 80 wt % of the first component.

Embodiment 12 provides the sealant composition of any one of Embodiments 1-11, wherein the polysulfide, polythioether, copolymer thereof, or combination thereof is about 30 wt % to about 95 wt % of the sealant composition.

Embodiment 13 provides the sealant composition of any one of Embodiments 1-12, wherein the polysulfide, polythioether, copolymer thereof, or combination thereof is about 40 wt % to about 70 wt % of the sealant composition.

Embodiment 14 provides the sealant composition of any one of Embodiments 1-13, wherein the polysulfide, polythioether, or copolymer thereof has a number-average molecular weight of about 500 g/mol to about 5,000 g/mol.

Embodiment 15 provides the sealant composition of any one of Embodiments 1-14, wherein the polysulfide, polythioether, or copolymer thereof has a number-average molecular weight of 500 g/mol to about 1,500 g/mol.

Embodiment 16 provides the sealant composition of any one of Embodiments 1-15, wherein the polysulfide, polythioether, or copolymer thereof has a mercaptan content of about 0.1 wt % to about 20 wt %, based on the overall weight of the liquid polysulfide.

Embodiment 17 provides the sealant composition of any one of Embodiments 1-16, wherein the polysulfide, polythioether, or copolymer thereof has a mercaptan content of about 1 wt % to about 10 wt %, based on the overall weight of the liquid polysulfide.

Embodiment 18 provides the sealant composition of any one of Embodiments 1-17, wherein the first component further comprises a filler, pigment, adhesion promotor, plasticizer, or a combination thereof.

Embodiment 19 provides the sealant composition of any one of Embodiments 1-18, wherein the glycol di((C₁-C₂₀)hydrocarbylcarboxylate ester is a glycol diphenylcarboxylate ester, wherein at each occurrence the phenyl group is independently substituted or unsubstituted.

Embodiment 20 provides the sealant composition of any one of Embodiments 1-19, wherein the glycol di((C₁-C₂₀)hydrocarbylcarboxylate ester is a glycol dibenzoate ester.

Embodiment 21 provides the sealant composition of any one of Embodiments 1-20, wherein the glycol of the glycol di((C₁-C₂₀)hydrocarbylcarboxylate ester has the structure HO—(R—O)ₙ—H, wherein R is (C₂-C₃)hydrocarbylene and n is 1 to 100.

Embodiment 22 provides the sealant composition of any one of Embodiments 1-21, wherein the glycol of the glycol di((C₁-C₂₀)hydrocarbylcarboxylate ester is ethylene glycol, diethylene glycol, triethylene glycol, tetraethylene glycol, propylene glycol, dipropylene glycol, tripropylene glycol, tetrapropylene glycol, 2,2,4-trimethyl-1,3-pentanediol, or neopentyl glycol hydroxypivalate.

Embodiment 23 provides the sealant composition of any one of Embodiments 1-22, wherein the second component comprises more than one of the glycol di((C₁-C₂₀)hydrocarbyl)carboxylate esters.

Embodiment 24 provides the sealant composition of any one of Embodiments 1-23, wherein the second component comprises two of the glycol di((C₁-C₂₀)hydrocarbyl)carboxylate esters, wherein the glycol of one of the glycol di((C₁-C₂₀)hydrocarbyl)carboxylate esters has a greater molecular weight than the glycol of another one of the glycol di((C₁-C₂₀)hydrocarbyl)carboxylate esters.

Embodiment 25 provides the sealant composition of Embodiment 24, wherein the glycol di((C₁-C₂₀)hydrocarbyl)carboxylate ester having the greater molecular weight is dipropylene glycol dibenzoate and the glycol di((C₁-C₂₀)hydrocarbyl)carboxylate ester having the lesser molecular weight is diethylene glycol dibenzoate.

Embodiment 26 provides the sealant composition of any one of Embodiments 24-25, wherein the weight ratio of the glycol di((C₁-C₂₀)hydrocarbyl)carboxylate ester having the lesser molecular weight to the glycol di((C₁-C₂₀)hydrocarbyl)carboxylate ester having the greater molecular weight is about 1:1 to about 6:1.

Embodiment 27 provides the sealant composition of any one of Embodiments 24-26, wherein the weight ratio of the glycol di((C₁-C₂₀)hydrocarbyl)carboxylate ester having the lesser molecular weight to the glycol di((C₁-C₂₀)hydrocarbyl)carboxylate ester having the greater molecular weight is about 2:1 to about 5:1.

Embodiment 28 provides the sealant composition of any one of Embodiments 1-27, wherein the second component comprises diethylene glycol dibenzoate, dipropylene glycol dibenzoate, or a combination thereof.

Embodiment 29 provides the sealant composition of any one of Embodiments 1-28, wherein the second component comprises diethylene glycol dibenzoate and dipropylene glycol dibenzoate.

Embodiment 30 provides the sealant composition of any one of Embodiments 1-29, wherein the one or more glycol di((C₁-C₂₀)hydrocarbylcarboxylate esters are about 20 wt % to about 80 wt % of the second component.

Embodiment 31 provides the sealant composition of any one of Embodiments 1-30, wherein the one or more glycol di((C₁-C₂₀)hydrocarbylcarboxylate esters are about 30 wt % to about 60 wt % of the second component.

Embodiment 32 provides the sealant composition of any one of Embodiments 1-31, wherein the one or more glycol di((C₁-C₂₀)hydrocarbylcarboxylate esters are about 1 wt % to about 20 wt % of the sealant composition.

Embodiment 33 provides the sealant composition of any one of Embodiments 1-32, wherein the one or more glycol di((C₁-C₂₀)hydrocarbylcarboxylate esters are about 2 wt % to about 10 wt % of the sealant composition.

Embodiment 34 provides the sealant composition of any one of Embodiments 1-33, wherein the oxidizing agent is lead dioxide, manganese dioxide, p-quinone dioxime, zinc peroxide, or combination thereof.

Embodiment 35 provides the sealant composition of any one of Embodiments 1-34, wherein the oxidizing agent is manganese dioxide.

Embodiment 36 provides the sealant composition of any one of Embodiments 1-35, wherein the oxidizing agent is about 20 wt % to about 80 wt % of the second component.

Embodiment 37 provides the sealant composition of any one of Embodiments 1-36, wherein the oxidizing agent is about 30 wt % to about 60 wt % of the second component.

Embodiment 38 provides the sealant composition of any one of Embodiments 1-37, wherein the oxidizing agent is about 1 wt % to about 20 wt % of the sealant composition.

Embodiment 39 provides the sealant composition of any one of Embodiments 1-38, wherein the oxidizing agent is about 2 wt % to about 10 wt % of the sealant composition.

Embodiment 40 provides the sealant composition of any one of Embodiments 1-39, wherein the sealant composition is up to about 1.5 wt % water that is not complexed or incorporated with a drying agent.

Embodiment 41 provides the sealant composition of any one of Embodiments 1-40, wherein the sealant composition is up to about 0.5 wt % water that is not complexed or incorporated with a drying agent.

Embodiment 42 provides the sealant composition of any one of Embodiments 1-41, wherein the sealant composition is substantially free of water that is not complexed or incorporated with a drying agent.

Embodiment 43 provides the sealant composition of any one of Embodiments 1-42, wherein the sealant composition is substantially free of water.

Embodiment 44 provides the sealant composition of any one of Embodiments 1-43, wherein the second component further comprises a drying agent.

Embodiment 45 provides the sealant composition of Embodiment 44, wherein the drying agent comprises calcium oxide, barium oxide, molecular sieves, or a combination thereof.

Embodiment 46 provides the sealant composition of any one of Embodiments 44-45, wherein the drying agent is molecular sieves.

Embodiment 47 provides the sealant composition of any one of Embodiments 44-46, wherein the drying agent is a type 3A zeolite filler.

Embodiment 48 provides the sealant composition of any one of Embodiments 1-47, wherein the drying agent is about 0.01 wt % to about 20 wt % of the second component.

Embodiment 49 provides the sealant composition of any one of Embodiments 1-48, wherein the drying agent is about 0.1 wt % to about 10 wt % of the second component.

Embodiment 50 provides the sealant composition of any one of Embodiments 1-49, wherein the drying agent is about 0.0001 wt % to about 5 wt % of the sealant composition.

Embodiment 51 provides the sealant composition of any one of Embodiments 1-50, wherein the drying agent is about 0.001 wt % to about 1 wt % of the sealant composition.

Embodiment 52 provides the sealant composition of any one of Embodiments 1-51, wherein the second component further comprises a curing accelerator.

Embodiment 53 provides the sealant composition of Embodiment 52, wherein the curing accelerator comprises an organic amine catalyst, a thiuram sulfide accelerator, a fatty acid, or a combination thereof.

Embodiment 54 provides the sealant composition of any one of Embodiments 1-53, wherein the second component further comprises an organic amine catalyst.

Embodiment 55 provides the sealant composition of Embodiment 54, wherein the organic amine catalyst is an organic tertiary amine.

Embodiment 56 provides the sealant composition of any one of Embodiments 54-55, wherein the organic amine catalyst is guanidine or a guanidine derivative.

Embodiment 57 provides the sealant composition of any one of Embodiments 54-56, wherein the organic amine catalyst comprises tetramethylguanidine, diphenylguanidine, di-o-tolylguanidine, 1-(o-tolyl)biguanide, or a combination thereof.

Embodiment 58 provides the sealant composition of any one of Embodiments 54-57, wherein the organic amine catalyst is diphenylguanidine.

Embodiment 59 provides the sealant composition of any one of Embodiments 54-58, wherein the organic amine catalyst is about 0.001 wt % to about 10 wt % of the second component.

Embodiment 60 provides the sealant composition of any one of Embodiments 54-59, wherein the organic amine catalyst is about 0.01 wt % to about 5 wt % of the second component.

Embodiment 61 provides the sealant composition of any one of Embodiments 54-60, wherein the organic amine catalyst is about 0.00001 wt % to about 2 wt % of the sealant composition.

Embodiment 62 provides the sealant composition of any one of Embodiments 54-61, wherein the organic amine catalyst is about 0.0001 wt % to about 1 wt % of the sealant composition.

Embodiment 63 provides the sealant composition of any one of Embodiments 1-62, wherein the second component further comprises a thiuram sulfide accelerator.

Embodiment 64 provides the sealant composition of Embodiment 63, wherein the thiuram sulfide accelerator comprises tetramethyl thiuram monosulfide, tetramethyl thiuram disulfide, tetraethyl thiuram disulfide, tetrabutyl thiuram disulfide, dipentamethylene thiuram hexasulfide, dicyclohexamethylene thiuram disulfide, diisopropyl thiuram disulfide, bis(morpholinothiocarbonyl) sulfide, or a combination thereof.

Embodiment 65 provides the sealant composition of any one of Embodiments 63-64, wherein the thiuram sulfide accelerator is dipentamethylene thiuram hexasulfide.

Embodiment 66 provides the sealant composition of any one of Embodiments 63-65, wherein the thiuram sulfide accelerator is about 0.01 wt % to about 15 wt % of the second component.

Embodiment 67 provides the sealant composition of any one of Embodiments 63-66, wherein the thiuram sulfide accelerator is about 0.1 wt % to about 10 wt % of the second component.

Embodiment 68 provides the sealant composition of any one of Embodiments 63-67, wherein the thiuram sulfide accelerator is about 0.0001 wt % to about 3 wt % of the sealant composition.

Embodiment 69 provides the sealant composition of any one of Embodiments 63-68, wherein the thiuram sulfide accelerator is about 0.001 wt % to about 1 wt % of the sealant composition.

Embodiment 70 provides the sealant composition of any one of Embodiments 1-69, wherein the second component further comprises a fatty acid.

Embodiment 71 provides the sealant composition of Embodiment 70, wherein the fatty acid is a (C₆-C₁₀₀)fatty acid.

Embodiment 72 provides the sealant composition of any one of Embodiments 70-71, wherein the fatty acid is stearic acid.

Embodiment 73 provides the sealant composition of any one of Embodiments 70-72, wherein the fatty acid is about 0.001 wt % to about 10 wt % of the second component.

Embodiment 74 provides the sealant composition of any one of Embodiments 70-73, wherein the fatty acid is about 0.01 wt % to about 5 wt % of the second component.

Embodiment 75 provides the sealant composition of any one of Embodiments 70-74, wherein the fatty acid is about 0.00001 wt % to about 2 wt % of the sealant composition.

Embodiment 76 provides the sealant composition of any one of Embodiments 70-75, wherein the fatty acid is about 0.0001 wt % to about 0.5 wt % of the sealant composition.

Embodiment 77 provides the sealant composition of any one of Embodiments 1-76, further comprising a filler.

Embodiment 78 provides the sealant composition of Embodiment 77, wherein the filler is a silica filler.

Embodiment 79 provides the sealant composition of any one of Embodiments 77-78, wherein the filler is about 0.001 wt % to about 10 wt % of the second component.

Embodiment 80 provides the sealant composition of any one of Embodiments 77-79, wherein the filler is about 0.01 wt % to about 5 wt % of the second component.

Embodiment 81 provides the sealant composition of any one of Embodiments 77-80, wherein the filler is about 0.00001 to about 2 wt % of the sealant composition.

Embodiment 82 provides the sealant composition of any one of Embodiments 77-81, wherein the filler is about 0.0001 wt % to about 0.5 wt % of the sealant composition.

Embodiment 83 provides the sealant composition of any one of Embodiments 1-82, wherein the sealant composition is substantially free of poly(ethylene-vinyl acetate).

Embodiment 84 provides the sealant composition of any one of Embodiments 1-83, wherein the sealant composition is substantially free of phthalates, chlorinated paraffins, butyl diglycols, hydrogenated terphenyls, or a combination thereof.

Embodiment 85 provides the sealant composition of any one of Embodiments 1-84, wherein the second component further comprises a filler, pigment, adhesion promotor, plasticizer, or a combination thereof.

Embodiment 86 provides the sealant composition of any one of Embodiments 1-85, wherein a reaction mixture comprising a mixture of the first component and the second component has a Tack-Free Time at room temperature of about 0.5 h to about 15 h after mixing of the first component and the second component.

Embodiment 87 provides the sealant composition of any one of Embodiments 1-86, wherein a reaction mixture comprising a mixture of the first component and the second component has a Tack-Free Time at room temperature of about 2 h to about 8 h after mixing of the first component and the second component.

Embodiment 88 provides the sealant composition of any one of Embodiments 1-87, wherein a reaction mixture comprising a mixture of the first component and the second component has a cure time at room temperature of about 0.5 h to about 15 h after mixing of the first component and the second component.

Embodiment 89 provides the sealant composition of any one of Embodiments 1-88, wherein a reaction mixture comprising a mixture of the first component and the second component has a cure time at room temperature of about 3 h to about 9 h after mixing of the first component and the second component.

Embodiment 90 provides the sealant composition of any one of Embodiments 1-89, wherein a reaction mixture comprising a mixture of the first component and the second component has an Application Time at room temperature of about 10 g/min to about 300 g/min about 2 hours after mixing of the first component and the second component.

Embodiment 91 provides the sealant composition of any one of Embodiments 1-90, wherein a reaction mixture comprising a mixture of the first component and the second component has an Application Time at room temperature of about 15 g/min to about 150 g/min about 2 hours after mixing of the first component and the second component.

Embodiment 92 provides the sealant composition of any one of Embodiments 1-91, wherein, after curing at room temperature, a reaction mixture comprising a mixture of the first component and the second component has a cured strength of about 10 A to about 75 A.

Embodiment 93 provides the sealant composition of any one of Embodiments 1-92, wherein, after curing at room temperature, a reaction mixture comprising a mixture of the first component and the second component has a cured strength of about 20 A to about 50 A.

Embodiment 94 provides the sealant composition of any one of Embodiments

1-93, wherein the first composition comprises the first component, wherein the first component is about 80 wt % to about 95 wt % of the sealant composition, wherein the polysulfide, polythioether, copolymer thereof, or a combination thereof is about 50 wt % to about 80 wt % of the first component; and

the second component, wherein the second component is about 5 wt % to about 20 wt % of the sealant composition, wherein the second component comprises

the one or more glycol di((C₁-C₂₀)hydrocarbyl)carboxylate esters, wherein the one or more glycol di((C₁-C₂₀)hydrocarbyl)carboxylate esters are about 20 wt % to about 80 wt % of the second component;

the oxidizing agent, wherein the oxidizing agent is about 20 wt % to about 80 wt % of the second component, wherein the oxidizing agent is manganese dioxide;

an organic amine catalyst, wherein the organic amine catalyst is about 0.001 wt % to about 10 wt % of the second component, wherein the organic amine catalyst is diphenylguanidine;

a fatty acid, wherein the fatty acid is about 0.001 wt % to about 10 wt % of the second component, wherein the fatty acid is stearic acid;

a thiuram sulfide accelerator, wherein the thiuram sulfide accelerator is about 0.01 wt % to about 15 wt % of the second component, wherein the thiuram sulfide accelerator is dipentamethylene thiuram hexasulfide;

a filler, wherein the filler is about 0.001 wt % to about 10 wt % of the second component; and

a drying agent, wherein the drying agent is about 0.01 wt % to about 20 wt % of the second component, wherein the drying agent is molecular sieves;

wherein

the sealant composition is up to about 1.5 wt % water that is not complexed or incorporated with the drying agent, and

the sealant composition is substantially free of alkyl phenol ethoxylate surfactants, poly(ethylene-vinyl acetate), phthalates, chlorinated paraffins, butyl diglycols, and hydrogenated terphenyls.

Embodiment 95 provides the sealant composition of any one of Embodiments 1-94, wherein the first composition comprises

the first component, wherein the first component is about 80 wt % to about 95 wt % of the sealant composition; and

the second component, wherein the second component is about 5 wt % to about 20 wt % of the sealant composition, wherein the second component comprises

the one or more glycol di((C₁-C₂₀)hydrocarbyl)carboxylate esters, wherein the one or more glycol di((C₁-C₂₀)hydrocarbyl)carboxylate esters are about 20 wt % to about 80 wt % of the second component, wherein the one or more glycol di((C₁-C₂₀)hydrocarbyl)carboxylate esters are diethylene glycol dibenzoate and dipropylene glycol dibenzoate in a weight ratio of about 1:1 to about 6:1;

the oxidizing agent, wherein the oxidizing agent is about 20 wt % to about 80 wt % of the second component, wherein the oxidizing agent is manganese dioxide;

an organic amine catalyst, wherein the organic amine catalyst is about 0.001 wt % to about 10 wt % of the second component, wherein the organic amine catalyst is diphenylguanidine;

a fatty acid, wherein the fatty acid is about 0.001 wt % to about 10 wt % of the second component, wherein the fatty acid is stearic acid;

a thiuram sulfide accelerator, wherein the thiuram sulfide accelerator is about 0.01 wt % to about 15 wt % of the second component, wherein the thiuram sulfide accelerator is dipentamethylene thiuram hexasulfide;

a silica filler, wherein the silica filler is about 0.001 wt % to about 10 wt % of the second component, wherein the silica filler is fumed silica; and

a drying agent, wherein the drying agent is about 0.01 wt % to about 20 wt % of the second component, wherein the drying agent is molecular sieves.

Embodiment 96 provides a reaction mixture comprising a mixture comprising the first component and the second component of the sealant composition of any one of Embodiments 1-95.

Embodiment 97 provides a kit comprising the first component and the second component of the sealant composition of any one of Embodiments 1-95, wherein the first component and the second component are separate.

Embodiment 98 provides a cured product of the sealant composition of any one of Embodiments 1-95.

Embodiment 99 provides a method of making the cured product of Embodiment 98, the method comprising:

mixing the first component and the second component to form a reaction mixture; and

curing the reaction mixture to form the cured product of Embodiment 98.

Embodiment 100 provides a method of sealing a surface comprising:

mixing the first component and the second component of the sealant composition of any one of Embodiments 1-95 to form a reaction mixture; and

applying the reaction mixture to the surface to be sealed.

Embodiment 101 provides a sealant composition comprising:

a first component, wherein the first component is about 80 wt % to about 95 wt % of the sealant composition; and

a second component, wherein the second component is about 5 wt % to about 20 wt % of the sealant composition, wherein the second component comprises

one or more glycol di((C₁-C₂₀)hydrocarbyl)carboxylate esters, wherein the one or more glycol di((C₁-C₂₀)hydrocarbyl)carboxylate esters are about 20 wt % to about 80 wt % of the second component, wherein the one or more glycol di((C₁-C₂₀)hydrocarbyl)carboxylate esters are diethylene glycol dibenzoate and dipropylene glycol dibenzoate in a weight ratio of about 1:1 to about 6:1;

an oxidizing agent, wherein the oxidizing agent is about 20 wt % to about 80 wt % of the second component, wherein the oxidizing agent is manganese dioxide;

an organic amine catalyst, wherein the organic amine catalyst is about 0.001 wt % to about 10 wt % of the second component, wherein the organic amine catalyst is diphenylguanidine;

a fatty acid, wherein the fatty acid is about 0.001 wt % to about 10 wt % of the second component, wherein the fatty acid is stearic acid;

a thiuram sulfide accelerator, wherein the thiuram sulfide accelerator is about 0.01 wt % to about 15 wt % of the second component, wherein the thiuram sulfide accelerator is dipentamethylene thiuram hexasulfide;

a silica filler, wherein the silica filler is about 0.001 wt % to about 10 wt % of the second component, wherein the silica filler is fumed silica; and

a drying agent, wherein the drying agent is about 0.01 wt % to about 20 wt % of the second component, wherein the drying agent is molecular sieves;

wherein

the sealant composition is up to about 1.5 wt % water that is not complexed or incorporated with the drying agent, and

the sealant composition is substantially free of alkyl phenol ethoxylate surfactants, poly(ethylene-vinyl acetate), phthalates, chlorinated paraffins, butyl diglycols, and hydrogenated terphenyls.

Embodiment 102 provides the sealant composition, reaction mixture, kit, cured product, or method of any one or any combination of Embodiments 1-101 optionally configured such that all elements or options recited are available to use or select from.

1. A sealant composition comprising:
a first component comprising a liquid that is a polysulfide, a polythioether, a copolymer thereof, or a combination thereof; and
a second component comprising
one or more glycol di((C₁-C₂₀)hydrocarbyl)carboxylate esters, wherein at each occurrence the (C₁-C₂₀)hydrocarbyl is independently substituted or unsubstituted; and
an oxidizing agent.

2. The sealant composition of claim 1, wherein the sealant composition is substantially free of water that is not complexed or incorporated with a drying agent.

3. The sealant composition of claim 1, wherein the second component further comprises a drying agent.

4. The sealant composition of claim 1, wherein the second component further comprises a curing accelerator.

5. The sealant composition of claim 1, wherein the second component further comprises an organic amine catalyst.

6. The sealant composition of claim 1, wherein the second component further comprises a thiuram sulfide accelerator.

7. The sealant composition of claim 1, wherein the second component further comprises a fatty acid.

8. The sealant composition of claim 1, further comprising a filler.

9. The sealant composition of claim 1, wherein the sealant composition is substantially free of poly(ethylene-vinyl acetate), phthalates, chlorinated paraffins, butyl diglycols, hydrogenated terphenyls, or a combination thereof.

10. A reaction mixture comprising a mixture comprising the first component and the second component of the sealant composition of claim 1.

11. A kit comprising the first component and the second component of the sealant composition of claim 1, wherein the first component and the second component are separate.

12. A cured product of the sealant composition of claim 1.

13. A method of making the cured product of claim 12, the method comprising:
mixing the first component and the second component to form a reaction mixture; and
curing the reaction mixture to form the cured product of claim 12.

14. A method of sealing a surface comprising:
mixing the first component and the second component of the sealant composition of claim 1 to form a reaction mixture; and
applying the reaction mixture to the surface to be sealed.

15. A sealant composition comprising:
a first component, wherein the first component is about 80 wt % to about 95 wt % of the sealant composition; and
a second component, wherein the second component is about 5 wt % to about 20 wt % of the sealant composition, wherein the second component comprises
one or more glycol di((C₁-C₂₀)hydrocarbyl)carboxylate esters, wherein the one or more glycol di((C₁-C₂₀)hydrocarbyl)carboxylate esters are about 20 wt % to about 80 wt % of the second component, wherein the one or more glycol di((C₁-C₂₀)hydrocarbyl)carboxylate esters are diethylene glycol dibenzoate and dipropylene glycol dibenzoate in a weight ratio of about 1:1 to about 6:1;
an oxidizing agent, wherein the oxidizing agent is about 20 wt % to about 80 wt % of the second component, wherein the oxidizing agent is manganese dioxide;
an organic amine catalyst, wherein the organic amine catalyst is about 0.001 wt % to about 10 wt % of the second component, wherein the organic amine catalyst is diphenylguanidine;
a fatty acid, wherein the fatty acid is about 0.001 wt % to about 10 wt % of the second component, wherein the fatty acid is stearic acid;
a thiuram sulfide accelerator, wherein the thiuram sulfide accelerator is about 0.01 wt % to about 15 wt % of the second component, wherein the thiuram sulfide accelerator is dipentamethylene thiuram hexasulfide;
a silica filler, wherein the silica filler is about 0.001 wt % to about 10 wt % of the second component, wherein the silica filler is fumed silica; and
a drying agent, wherein the drying agent is about 0.01 wt % to about 20 wt % of the second component, wherein the drying agent is molecular sieves;
wherein
the sealant composition is up to about 1.5 wt % water that is not complexed or incorporated with the drying agent, and
the sealant composition is substantially free of alkyl phenol ethoxylate surfactants, poly(ethylene-vinyl acetate), phthalates, chlorinated paraffins, butyl diglycols, and hydrogenated terphenyls.
